(19) United States
(12) Patent Application Publication
(10) Pub. No.: US 2004/0251128 A1
(43) Pub. Date: Dec. 16, 2004

(54) Gas diffusion electrode support structure

(76) Inventors: Peter Weuta, Leverkusen (DE); Fritz Gestermann, Leverkusen (DE); Hans-Dieter Pinter, Wermelskirchen (DE); Walter Klesper, Bergisch Gladbach (DE)

Correspondence Address: CONNOLLY BOVE LODGE & HUTZ LLP, SUITE 800, 1990 M STREET NW, WASHINGTON, DC, 20036-3425, US

(21) Appl. No.: 10/493,442

(22) PCT Filed: Oct. 16, 2002
(86) PCT No.: PCT/EP02/11555

(30) Foreign Application Priority Data
Oct. 25, 2001 (DE) 10152792.6

(51) Int. Cl. B23H 7/22

(52) U.S. Cl. 204/288.2

(57) ABSTRACT

The invention relates to a gas diffusion electrode support structure that receives a gas diffusion electrode (10) for an electrochemical reactor. Said support structure has a base structure (8) to whose fin (11) a connecting element is connected via a weld seam (20) in an electrically conductive way. The connecting element is configured as a bent structure and encloses an edge area (15) of the gas diffusion electrode (10). The edge area (15) of the gas diffusion electrode (10), in an external section (32), is not coated, and in an interior section (33) is provided with an electrochemically active coating.

The invention relates to a support structure for a gas diffusion electrode. The support structure is used to receive a gas diffusion electrode for an electrochemical reaction apparatus. The invention relates in particular to a gas diffusion electrode support structure for an electrolysis or fuel cell.

One method of integrating gas diffusion electrodes into the basic structure, and/or making electrical contact between gas diffusion electrodes and the basic structure, of an electrochemical reaction apparatus is the formation of a press-fit contact, as described for example in DE-A 44 44 114. However, when press-fit contacts are used, it has emerged that their electrical contact resistance often deteriorates during operation of the arrangement, resulting in an undesirable increase in the consumption of electrical energy.

An electrically more durable connection between gas diffusion electrodes and electrochemical reaction apparatus can be achieved with the aid of welding processes, as described for example in EP-A 1 041 176. If a gas diffusion electrode with an imperforated, encircling metallic edge is used, direct welding to the basic structure of the electrode is possible. The continuous edge of the electrode basic structure which is mentioned in EP-A 1 041 176 requires a perforated or slotted metal sheet as the support structure. Therefore, the electrodes which are to be integrated often comprise a metallically conducting basic structure which has open pores over its entire area and in the cavities in which the electrically active material, referred to below as coating, is embedded. Attempts to directly weld the coated electrode have failed on account of the fact that the coating material often decomposes at high joining temperatures.

Furthermore, the use of a material which has become plastic through heating and solidifies again during cooling as a sealing material is described in EP-A 1 029 946. In this case, chemically inert substances, such as PTFE, may be used. However, for this substance to be permanently connected to the basic structure, it is necessary to employ a high temperature of 200 to 400° C. Accordingly, carrying out the processes as described in EP-A 1 029 946 requires extensive apparatus and/or machinery.

The invention is based on the object of providing a gas diffusion support structure in which the gas diffusion electrode is held permanently in a sealed manner.

According to the invention, the object is achieved by means of the features of claim 1.

The support structure according to the invention for receiving a gas diffusion electrode for an electrochemical reaction apparatus, such as an electrolysis or fuel cell, has a basic structure. The basic structure is, for example, a frame-like housing half or the like of an electrolysis cell. The basic structure supports the gas diffusion electrode. According to the invention, for this purpose an electrically conductive connecting element is provided between the basic structure and the gas diffusion electrode, the connecting element preferably being electrically conductive with a low resistance. The provision of a connecting element makes it possible on the one hand to produce a permanent, electrically conductive connection to the basic structure and, on the other hand, to the gas diffusion electrode.

It is particularly preferable for the connecting element to be configured in such a manner that it surrounds the gas diffusion electrode in the edge region. This makes it possible for the gas diffusion electrode not to be provided with coating material in the edge region, so that exclusively an uncovered metallic grid or the like is present. A connection of good electrical conductivity can be realized for the metallic grid or a metallic support structure. In this context, it is particularly preferable for the gas diffusion electrode to be kept at least partially and preferably completely free of coating in an outer part of the edge region, such as a narrow, strip-like outer region resembling a frame, and furthermore to provide an electrochemically active coating in an inner part of the edge region. This coating otherwise corresponds to the overall coating provided on the gas diffusion electrode. This means that only a part of the edge region which is surrounded by the connecting element is free of coating, and therefore good electrical contact can be realized in this region. It is preferable for that part of the edge region at which the transition between the region of the gas diffusion electrode which is covered by the connecting element and the free gas diffusion electrode is present to be coated with electrochemically active material.

The absence of coating material in the welding zone allows a connection of perfect quality to be achieved. Therefore, in this region the open-pored catalyst support of the gas diffusion electrode is free of coating material and would without measures to achieve a sealing action allow the media situated on the two sides of the electrode, namely gas and liquid electrolyte, to mix when the electrochemical reaction apparatus is operating. To counteract this situation, which is undesirable in processes such as for example the electrolysis of alkaline metal chlorides with an oxygen consuming cathode, the uncoated weld zone could be provided with materials which are liquid or pasty at the time of application and solidify after a certain time and which seal the open-pored structure at this location. Solidification of the sealing materials could occur, for example, through chemical curing of a substance applied in liquid or pasty form. On account of the chemically generally highly aggressive conditions which are present in the electrochemical reaction apparatus, the service life of seals of this type has proven very short—in the region of weeks or a few months—a factor which prevents efficient long-term use of the electrochemical reaction apparatus.

Good sealing at the edge of the connecting element can be achieved in particular by the provision of a connecting element which surrounds the edge region of the gas diffusion electrode in the manner of a fold, wherein, in a preferred refinement, only part of the edge region is free of coating. This can be achieved by pressing on the connecting element, which is preferably a plastic deformable material, in particular metal sheet. In this case, it is possible to provide an encircling shoulder which allows a relatively good seal to be achieved at the gas diffusion electrode. However, it is particularly preferable for a seal to be provided between the connecting element and the edge region of the gas diffusion electrode, in particular the inner part of the edge region, i.e. the edge region provided with a coating. The media located on the two sides are reliably separated in the connecting region of electrode and connecting element by the seal, which may be an elastic or plastic seal.

The seal is preferably able to withstand the liquids and gases present in the reaction apparatus, in particular lyes. It is particularly preferable for an elastic seal made from ethylene-propylene-diene terpolymer (EPDM) or a plastic seal made from polytetrafluorethylene (PTFE) or seals which include these constituents to be provided.

In the region of the seal, the connecting element preferably has a fold-like configuration. In particular this fold allows a sealed closure to be achieved by plastic deformation of the connecting element. When a fold of this nature is provided, it is particularly advantageous instead of one of the existing seals or additionally to provide a sealing compound, which is preferably viscous.

The force with which the connecting element is deformed and presses onto the seal is preferably effected by means of a linear force of at least 10 kg/cm, preferably at least 50 kg/cm, and particularly preferably at least 100 kg/cm.

The frame surrounding the gas diffusion electrode is produced by welding two pairs of open metal profiled sections, which are preferably of different lengths. The ends of the shorter profiled sections are advantageously of identical form over the entire length; the long profiled sections are notched in the edge region—in this region they only have the appearance of a flat metal sheet. When an automated welding process is used in which a continuous movement of the welding head has an advantageous effect on the time required to weld in the electrode, this different shaping allows rapid entry to and exit from the weld area.

The connecting element preferably comprises a plurality of connecting parts or profiled sections. It is also possible for the seal to comprise a plurality of seal parts. In this case, connecting locations between connecting parts are arranged offset with respect to the connecting locations between seal parts, so that there is little or no contact or crossing between the connecting locations. The connection between the connecting parts or profiled sections can be made either as a butt joint (90°) or as a mitred joint (45°).

The finished frame is composed of an outer flat region and an open inner region. The planar region is used to attach the frame to the basic structure of the electrochemical reaction apparatus, while the open region is used to receive the electrode.

The frame preferably consists of nickel or a lye-resistant nickel alloy, in particular a nickel-silver alloy, or of nickel which is coated with silver or of some other lye-resistant metal alloy.

When the electrode is integrated in the frame in accordance with the invention, it is welded into the open, metallic region of the frame at its edge which is free of coating, so as to form a seam running continuously or discontinuously. Then, the elastic or plastic seal is introduced and the frame structure is closed by the application of pressure. After the structure has been closed, therefore, the sealing force is applied by the elastic clamping force of the bent-over sheet-metal folds. The electrode, which is completely sealed and surrounded by a frame, is integrated in the electrochemical reaction apparatus by means of a continuous weld seam.

The material of the basic structure, like the frame structure according to the invention, preferably consists of nickel or a lye-resistant nickel alloy, in particular a nickel-silver alloy, or of nickel which is coated with silver, or of another lye-resistant metal alloy. The thickness of the metal sheets from which the frame structure according to the invention is made is at most 1 mm, preferably 0.1 to 1 mm, particularly preferably 0.2 to 1 mm.

The electrochemically active coating of the gas diffusion electrode includes a compound of the catalyst material, for example silver(I)oxide and a binder, e.g. a polymer, such as polytetrafluorethylene (PTFE). Furthermore, the coating material may contain carbon or a carbon-containing compound and additives, e.g. ammonium hydrogen carbonate, which function inter alia as pore-forming agents.

The catalyst support is a mesh, woven fabric, braided fabric, nonwoven or foam made from nickel, if appropriate with a silver plating, or a nickel alloy, in particular a nickel-silver alloy.

Either a continuous seam or weld spots or stitch welds can be used to weld the gas diffusion electrode onto an open frame structure by means of conventional processes, such as, for example, laser, resistance, metal reactive gas, metal inert gas, fuel gas, tungsten inert gas, plasma or ultrasonic welding processes. Alternatively, the gas diffusion electrode can also be joined to the frame structure by means of a soldering process.

To weld the frame which has already been provided with an electrode into the basic structure of the electrochemical reaction apparatus, in view of the need to avoid leaks welding processes which make it possible to produce a continuous seam are particularly suitable. By way of example, laser, metal reactive gas, metal inert gas, fuel gas, tungsten inert gas and plasma welding processes are particularly suitable for this purpose. Alternatively, it is also possible to use a soldering process.

If the procedures described above are applied, it has emerged that when a frame surrounding the electrode is employed, the force applied to the seal by the fold is sufficient to reliably seal the electrode with respect to the frame. It was possible to demonstrate this even when using a soft structural material for the frame structure, such as nickel for example.

The electrode which has been integrated into an electrochemical reaction apparatus using the process according to the invention may preferably, although not exclusively, be used for the following processes:

alkali metal chloride electrolysis with oxygen-consuming cathode

hydrochloric acid electrolysis with oxygen-consuming cathode

electrochemical recycling of waste materials

electrosyntheses of organic or inorganic substances

generation of energy by means of fuel cell processes

Furthermore, the invention relates to a gas diffusion electrode having a connecting element which is electrically conductively connected in the edge region of the gas diffusion electrode. The gas diffusion electrode according to the invention is particularly suitable for connection to a basic structure, as described above. The configuration and connection of the connecting element to the gas diffusion electrode is likewise preferably configured as described above.

The invention is explained in more detail below on the basis of preferred embodiments and with reference to the appended drawings, in which:

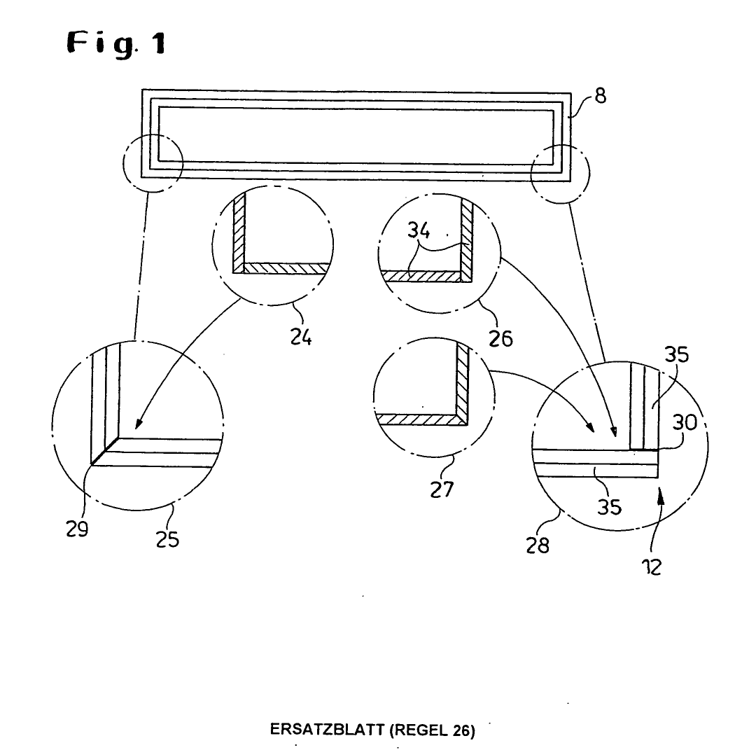

FIG. 1 shows a connecting element in combination with a seal,

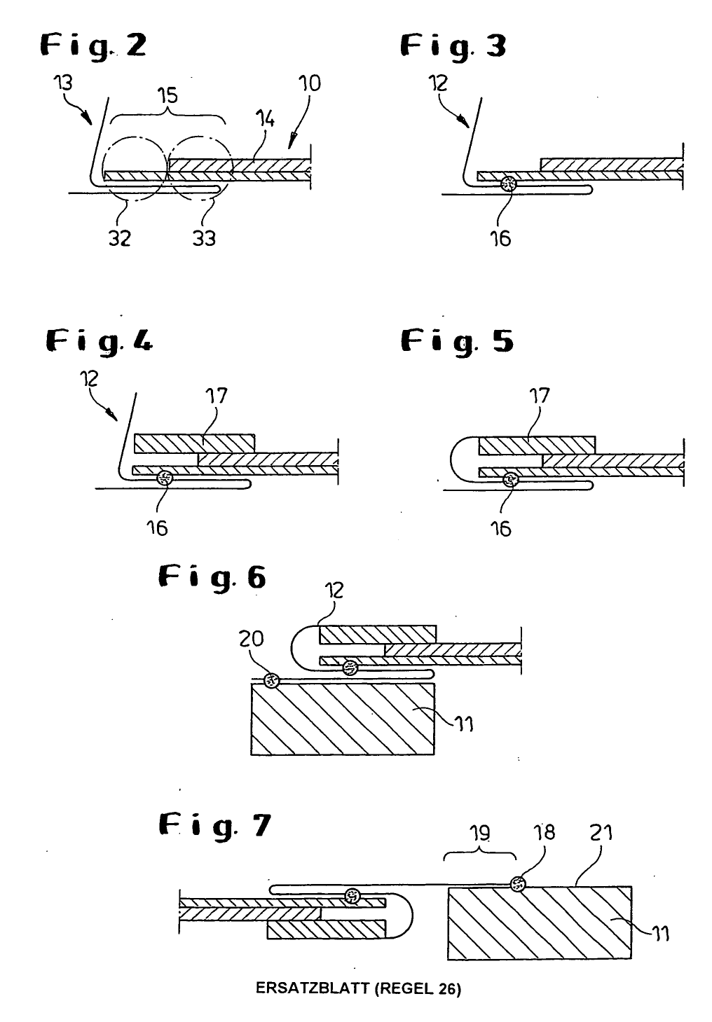

FIGS. 2-5 show various process steps involved in the production of the gas diffusion electrode support structure according to the invention,

FIG. 6 shows a first embodiment of the gas diffusion electrode support structure according to the invention, and

FIG. 7 shows a second embodiment of the gas diffusion electrode support structure according to the invention.

### EXAMPLES

The connection of a gas diffusion electrode to a gas pocket with the aid of the support structure according to the invention is described with reference to the examples below. The gas pocket has a basic structure 8 in the form of a half-shell (FIG. 1) with a length of 1800 mm and a width of 250 mm. The gas diffusion electrode 10 (FIG. 2) is first of all introduced into a connecting element 12 (FIG. 3), in this case a self-supporting frame made from nickel, which is then connected to a web 11 (FIG. 6, 7) of the basic structure 8. A gas pocket of this type was used in an alkali metal chloride electrolysis cell. In this case, the gas diffusion electrode was operated as an oxygen-consuming cathode.

### Example 1

To produce the frame, which forms the connecting element 12 between gas diffusion electrode 10 and basic structure 8, four linear profiled sections made from nickel sheet (thickness: 1 mm) were cut in mitred form, as shown in the enlarged view 25 in FIG. 1, and joined in the corner regions 29, by means of tungsten inert gas (TIG) welding, to form a rectangular frame. The gas diffusion electrode 10 was inserted into the open profiled section 13 (FIG. 2) of the connecting element 12. In the process, the edge region 15 of the gas diffusion electrode was inserted into the open connecting element 12. The edge region 15, which runs all the way along the four sides of the gas diffusion electrode 10, is formed by an outer part 32 without an electrochemically active coating and an inner part 33 with a coating. The gas diffusion electrode 10 is welded to the frame 12 along a line 16 (FIG. 3), for example by means of ultrasonic welding.

The sealing action to separate the different media located on the two sides of the electrode, namely oxygen and electrolyte, is brought about by the use of an elastic seal 17 made from lye-resistant EPDM. The seal 17 is assembled from four parts which adjoin one another with a butt joint 24 (FIG. 1) and is inserted into the open profiled section 13 (FIG. 4). The profiled section 13 is closed by the application of pressure with a linear force of 200 kg/cm (FIG. 5). The combination of a basic structure 8 cut as a mitred joint and a seal 17 which is not formed as a mitred joint, but rather as a right-angled butt connection, means that a seal is produced even in the corners.

In a first embodiment, the electrode 10, which is completely surrounded by a frame, is positioned on the web 11 of the basic structure in such a manner that the entire frame 12 with the gas diffusion electrode 10 part surrounded by a fold is seated on the web (FIG. 6). This form of integration has the advantage of minimizing the unused surface area of the gas diffusion electrode 10, since the electrochemically inactive part of the electrode 10 surrounded by a frame overlaps the web of the basic structure 8. The frame is joined to the basic structure 8 by means of a laser weld seam 20 in the edge region. The use of this welding process has the advantage of a high joining speed and of little heat being introduced into the structure, so that thermal damage to the seal or the electrode coating can be avoided.

### Example 2

In a second preferred embodiment, the integration of the electrode into the basic structure of the gas pocket of the alkali metal chloride electrolysis cell is similar to the embodiment described in Example 1, with production being identical to the production described in FIG. 2-5. The difference between the two embodiments lies in the seal and its geometry and in the way in which the frame 12 is connected to the web 11 of the basic structure 8.

The seal 17, which in the exemplary embodiment illustrated comprises four seal parts 34, is joined together by butt joints 26 in the corner region (FIG. 1). The four profiled sections 35 of the connecting element 12 are likewise connected to one another by butt joints, as illustrated in the enlarged view 28 shown in FIG. 1. The abutment lines of seal 17 and connecting element 12 are arranged at right angles to one another and therefore are not congruent with one another. A plastic seal made from polytetrafluorethylene (PTFE) is used. The corners of the connecting element 12 are welded along the edge 30 by means of tungsten inert gas (TIG) welding; after the electrode 10 has been welded in (cf. Example 1), it is closed up using a linear force of 400 kg/cm.

The electrode 10 which is completely surrounded by a frame is positioned on the web 11 of the basic structure 8 in such a manner that only an edge region 19 of the connecting element 12 rests on the web, whereas that part of the gas diffusion electrode which is surrounded by a fold projects into the gas pocket (FIG. 7). The connecting element 12 is welded to the web 11 along a weld seam 18. This type of orientation makes it possible to reliably avoid contact between the frame structure and the ion exchange membrane which separates the cathode half-cell from the anode half-cell.

### Example 3

In a third embodiment, similarly to the embodiment described in Example 1, an elastic seal made from EPDM is used, the difference being that the four parts of the seal are cut into a mitred joint (cf. FIG. 1: 27), while the four parts of the frame are cut into a butt joint.

After the electrode has been welded into the open profiled section 13 (cf. Example 1), the profiled section 12 is closed up with a linear force of 250 kg/cm.

The way in which the electrode is integrated into the basic structure of the alkali metal chloride electrolysis cell is identical to the variant carried out in Example 2 (cf. FIG. 7).

1. A gas diffusion electrode support structure for receiving a gas diffusion electrode for an electrochemical reaction apparatus, having a basic structure, and
a gas diffusion electrode supported by the basic structure, and
an electrically conductive connecting element arranged between the basic structure and the gas diffusion electrode.

2. The gas diffusion electrode support structure as claimed in claim 1, wherein a connecting element surrounds an edge region of the gas diffusion electrode.

3. The gas diffusion electrode support structure as claimed in claim 2, characterized in that an outer part of the edge region of the gas diffusion electrode is at least partially free of coating, and an inner part of the edge region is provided with an electrochemically active coating.

4. The gas diffusion electrode support structure as claimed in claim 1, further comprising a seal provided between the connecting element and the edge region.

5. The gas diffusion electrode support structure as claimed in claim 4, wherein in order to achieve the sealing action, the connecting element is plastically deformed in the region of the seal.

6. The gas diffusion electrode support structure as claimed in claim 1, wherein the connecting element surrounds the gas diffusion electrode in the form of a frame.

7. The gas diffusion electrode support structure as claimed in claim 1, wherein the connecting element comprises a plurality of connecting parts, the seal comprises a plurality of seal parts and the connecting locations of the connecting parts and of the seal parts are offset with respect to one another.

8. A gas diffusion electrode support structure as claimed in claim 4, wherein the seal is provided between the connecting element and an inner part of the edge region.

9. The gas diffusion electrode support structure as claimed in claim 2, further comprising a seal provided between the connecting element and the edge region.

10. The gas diffusion electrode support structure as claimed in claim 3, further comprising a seal provided between the connecting element and the edge region.

11. The gas diffusion electrode support structure as claimed in claim 2, wherein the connecting element surrounds the gas diffusion electrode in the form of a frame.

12. The gas diffusion electrode support structure as claimed in claim 3, wherein the connecting element surrounds the gas diffusion electrode in the form of a frame.

13. The gas diffusion electrode support structure as claimed in claim 4, wherein the connecting element surrounds the gas diffusion electrode in the form of a frame.

14. The gas diffusion electrode support structure as claimed in claim 5, wherein the connecting element surrounds the gas diffusion electrode in the form of a frame.

15. The gas diffusion electrode support structure as claimed in claim 2, wherein the connecting element comprises a plurality of connecting parts, the seal comprises a plurality of seal parts and the connecting locations of the connecting parts and of the seal parts are offset with respect to one another.

16. The gas diffusion electrode support structure as claimed in claim 3, wherein the connecting element comprises a plurality of connecting parts, the seal comprises a plurality of seal parts and the connecting locations of the connecting parts and of the seal parts are offset with respect to one another.

17. The gas diffusion electrode support structure as claimed in claim 4, wherein the connecting element comprises a plurality of connecting parts, the seal comprises a plurality of seal parts and the connecting locations of the connecting parts and of the seal parts are offset with respect to one another.

18. The gas diffusion electrode support structure as claimed in claim 5, wherein the connecting element comprises a plurality of connecting parts, the seal comprises a plurality of seal parts and the connecting locations of the connecting parts and of the seal parts are offset with respect to one another.

19. The gas diffusion electrode support structure as claimed in claim 6, wherein the connecting element comprises a plurality of connecting parts, the seal comprises a plurality of seal parts and the connecting locations of the connecting parts and of the seal parts are offset with respect to one another.
